(19) United States
(12) Patent Application Publication
(10) Pub. No.: US 2026/0152967 A1
(43) Pub. Date: Jun. 4, 2026

(54) FOLDING TENT WITH CASTER STRUCTURES

(71) Applicant: Linhai Zhenyi Arts & Crafts Co., Ltd., Zhejiang (CN)

(72) Inventor: Bin Wang, Zhejiang (CN)

(73) Assignee: Linhai Zhenyi Arts & Crafts Co., Ltd., Zhejiang (CN)

(21) Appl. No.: 19/204,569

(22) Filed: May 11, 2025

(30) Foreign Application Priority Data
Dec. 4, 2024 (CN) 202422981533.4

(51) Int. Cl. E04H 15/46; B60B 33/00; E04H 15/54; E04H 15/60

(52) U.S. Cl. CPC E04H 15/46; B60B 33/0044; E04H 15/54; E04H 15/60

(57) ABSTRACT

Disclosed in the present disclosure is a folding tent with caster structures. The folding tent includes tent leg tubes, where a movable base is assembled at the bottom of each of the tent leg tubes; and each of the movable bases includes a leg tube seat, a roller base, and a roller, the roller is mounted on one side of the roller base, the leg tube seat is mounted on the roller base, and the roller base is rotatable relative to the leg tube seat and is configured to move the roller. According to the present disclosure, by means of the movable bases, the folding tent can be conveniently moved, carried or fixed.

### CROSS-REFERENCE TO RELATED APPLICATION

This application claims the priority benefit of China application serial no. 202422981533.4, filed on Dec. 4, 2024. The entirety of the above-mentioned patent application is hereby incorporated by reference herein and made a part of this specification.

### BACKGROUND

### Technical Field

The present disclosure relates to the technical field of folding tents, in particular to a folding tent with caster structures.

### Description of Related Art

The alias of the folding tent is an advertising tent and an awning. The folding tent can be used for outdoor exhibitions and product promotion, celebration evenings, exhibitions, tourism, leisure, field work, food stalls, song and dance evenings and other temporary activities, as well as long-term leisure facilities in a park tourist resort scenic area. The folding tent is simple to operate, easy to mount, lightweight and durable, convenient to carry, capable of being used when opened and long in service life. A tent cloth is usually made of a high-quality material, is waterproof, sunproof, durable and easy to clean, and is suitable for use in all weathers. The tent does not need to be disassembled and assembled again after initial assembly, the operation is convenient and easy, and the tent is convenient to fold and store.

The folding tent is very common in daily life, and can be unfolded and folded, so that it is convenient to use, store and carry. After the tent is folded, in order to facilitate moving and carrying, a user usually insert the folded tent into a transport bag, and the transport bag needs to be connected to the tent to facilitate taking and dragging by the user. Besides, most of the existing folding tents are usually not equipped with matched roller structures, resulting in use limitations when the folding tents are stored in storage bags, so that the products are inconvenient to carry.

### SUMMARY

To solve the above problems, the present disclosure aims to provide a folding tent with caster structures, and by means of movable bases, the folding tent can be conveniently moved, carried or fixed.

The technical problems can be solved by the present disclosure through the following technical solution:

a folding tent with caster structures, including tent leg tubes, where a movable base is assembled at the bottom of each of the tent leg tubes; and each of the movable bases includes a leg tube seat, a roller base, and a roller, the roller is mounted on one side of the roller base, the leg tube seat is mounted on the roller base, and the roller base is rotatable relative to the leg tube seat and is configured to move the roller.

An upper hinge hole is formed in each of the leg tube seats, a lower hinge hole is formed in each of the roller bases, and a mounting shaft is matched between the upper hinge hole and the lower hinge hole.

A guide post is arranged at a lower end of each of the leg tube seats, a guide groove is formed in each of the roller bases, and the guide post moves relative to the guide groove and moves the roller base along the leg tube seat; and each of the guide grooves is in an arc groove shape.

A leg tube embedding groove is formed in each of the leg tube seats, a fixing hole is formed in the leg tube seat, the bottom of the tent leg tube is embedded into the embedding groove, and a fixing member penetrates through the fixing hole to fixedly mount the tent leg tube and the leg tube seat.

Two roller mounting arms are arranged on one side of each of the roller bases, the roller is located between the two roller mounting arms and is in rolling mounting fit through a roller shaft, and the lowest position of the roller is not lower than a horizontal plane where a bottom surface of the roller base is located.

The two rollers in the movable bases of the two adjacent tent leg tubes are capable of moving to the same outer side.

Two movable bases are provided, four tent leg tubes are provided, the bottoms of two adjacent tent leg tubes are configured to be matched with the movable bases, and the bottoms of another two tent leg tubes are configured to be matched with fixed bases.

Four movable bases are provided, four tent leg tubes are provided, and the bottom of each of the tent leg tubes is configured to be matched with the single movable base.

The folding tent with caster structures further includes leg tube locking seats, where each of the leg tube locking seats is mounted on the tent leg tube in a sleeving manner, the tent leg tube is divided into an upper leg tube and a lower leg tube, the leg tube locking seat is located between the upper leg tube and the lower leg tube, the lower leg tube is capable of extending and retracting in an inner cavity of the upper leg tube, and the leg tube locking seat is configured to extending and retracting locking of the upper leg tube and the lower leg tube.

A hanging ring is arranged on an outer side wall of each of the leg tube locking seats; the folding tent further includes a tent cover; the tent cover includes a cover body and several hanging ropes; lower ends of the hanging ropes are configured to be matched with the hanging rings; and when the folding tent is in a completely folded state, the tent cover is capable of being sleeved outside the folding tent.

Compared with the prior art, the present disclosure has the beneficial effects are as follows: according to the present disclosure, by means of the movable bases, the folding tent can be conveniently moved, carried or fixed; particularly, after the folding tent is retracted and folded, in combination with the tent cover, it is convenient to store as a whole; and in combination with the switching of the positions of the rollers, it is convenient to move.

The features of the present disclosure can be clearly understood by referring to drawings of this case and detailed description of the following preferred embodiments.

### BRIEF DESCRIPTION OF THE DRAWINGS

FIG. 1 is a schematic diagram of a breakdown structure of a movable base in the present disclosure;

FIG. 2 is a schematic diagram of an overall structure of a movable base in the present disclosure;

FIG. 3 is a schematic diagram of a mounting section structure of a leg tube seat and a roller base in the present disclosure;

FIG. 4 is a first schematic diagram of an overall mounting structure of a folding tent in the present disclosure; and

FIG. 5 is a second schematic diagram of an overall mounting structure of a folding tent in the present disclosure.

### DESCRIPTION OF THE EMBODIMENTS

In order to make the technical means, creative features, purposes and effects of the present disclosure easy to understand, the present disclosure is further illustrated below in combination with the specific drawings.

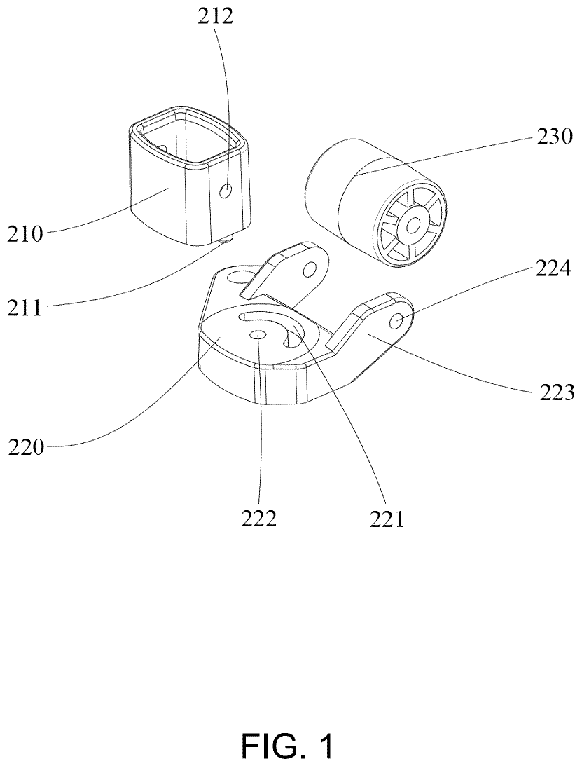

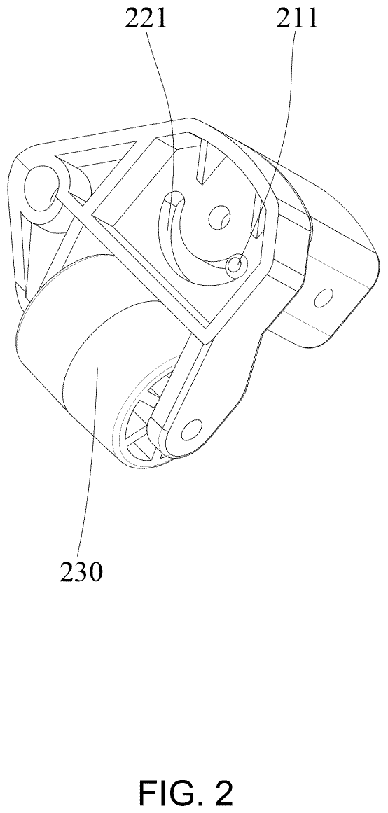

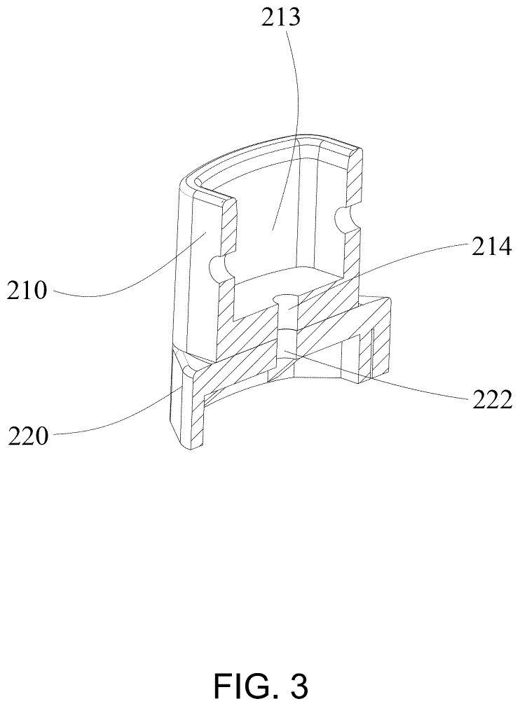

As shown in FIG. 1 to FIG. 5, the present disclosure discloses a folding tent with caster structures, including tent leg tubes 100, where a movable base 200 is assembled at the bottom of each of the tent leg tubes 100; and each of the movable bases 200 includes a leg tube seat 210, a roller base 220, and a roller 230, the roller 230 is mounted on one side of the roller base 220, the leg tube seat 210 is mounted on the roller base 220, and the roller base 220 is rotatable relative to the leg tube seat 210 and is configured to move the roller 230. Particularly, after the folding tent is folded, the positions of the rollers 230 are adjusted, and the rollers 230 are usually moved outwards, so that two external rollers 230 are provided on the same side; and a user inclines the folding tent, so that the rollers 230 abut against the ground, and the tent can be moved by means of the rollers 230.

In the specific structure, an upper hinge hole 214 is formed in each of the leg tube seats 210, a lower hinge hole 222 is formed in each of the roller bases 220, a mounting shaft is matched between the upper hinge hole 214 and the lower hinge hole 222, and the mounting shaft is a common hinge accessory in the prior art. The mounting structure for each leg tube seat 210 and each roller base 220 is optimized, and the roller base 220 can conveniently rotate relative to the leg tube seat 210 by means of the mounting shaft, thereby facilitating adjusting the position of the roller 230.

In view of the above, a guide post 211 is arranged at a lower end of each of the leg tube seats 210, a guide groove 221 is formed in each of the roller bases 220, and the guide post 211 moves relative to the guide groove 221 and moves the roller base 220 along the leg tube seat 210; and each of the guide grooves 221 is in an arc groove shape. The design of the structure of each guide groove 221 is optimized, so that the movement of the roller base 220 is guided; by means of the structural design of the guide groove 221, the roller 230 is embedded and folded at one end of the guide groove 221, and the roller 230 is externally placed and movable at the other end, thereby facilitating determining the use state.

In view of the above, a leg tube embedding groove 213 is formed in each of the leg tube seats 210, a fixing hole 212 is formed in the leg tube seat 210, the bottom of the tent leg tube 100 is embedded into the embedding groove 213, and a fixing member penetrates through the fixing hole 212; and each fixing member is a common components such as a fastening bolt and a fastening screw in the prior art, is configured to fixedly mount the tent leg tube 100 and the leg tube seat 210, thereby facilitating fixed mounting of the tent leg tube 100.

In view of the above, two roller mounting arms 223 are arranged on one side of each of the roller bases 220, the roller 230 is located between the two roller mounting arms 223 and is in rolling mounting fit through a roller shaft, the roller shaft is a common roller mounting component in the prior art, and the lowest position of the roller 230 is not lower than a horizontal plane where a bottom surface of the roller base 220 is located. Preferably, the two rollers 230 in the movable bases 200 of the two adjacent tent leg tubes 100 can be moved to the same outer side, the lowest positions of the rollers 230 and bottom panels of the roller bases 220 are usually located at the same horizontal height, and when the whole folding tent is folded and placed on the ground, the rollers 230 are usually not in contact with the ground, so that the folding tent can be stably placed; and after the rollers 230 are moved outwards, the user inclines the tent to make the rollers 230 come into contact with the ground, the roller bases 220 are separated from the ground, and the tent can be moved by means of the rollers 230.

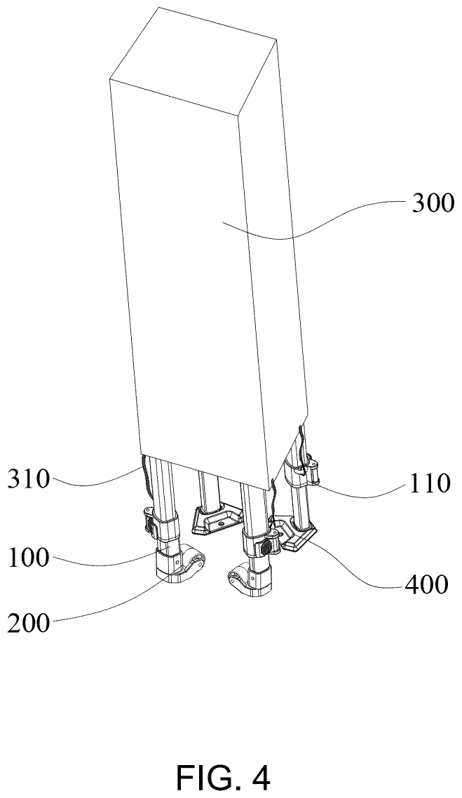

In one of the preferred embodiments, as shown in FIG. 4, two movable bases are provided, four tent leg tubes are provided, the bottoms of two adjacent tent leg tubes 100 are configured to be matched with the movable bases 200, and the bottoms of another two tent leg tubes 100 are configured to be matched with fixed bases 400.

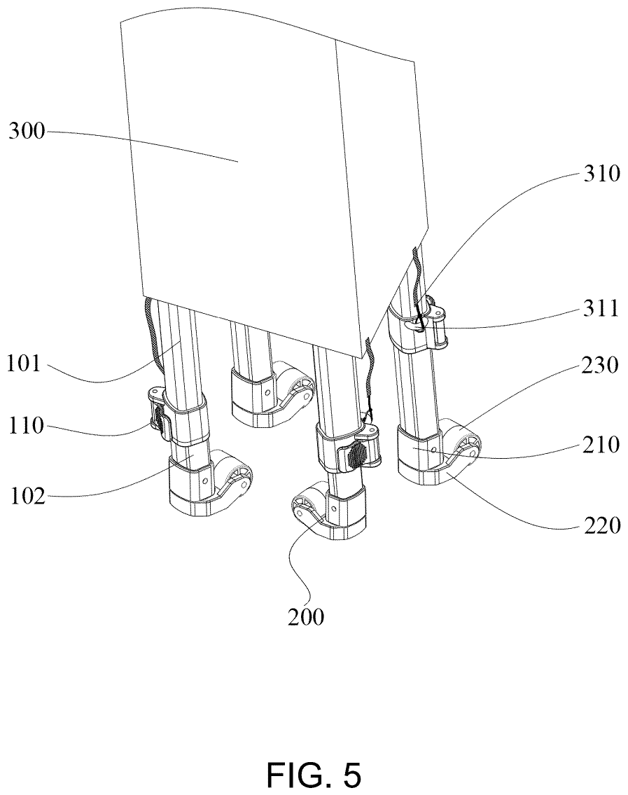

In one of the preferred embodiments, as shown in FIG. 5, four movable bases are provided, four tent leg tubes 100 are provided, and the bottom of each of the tent leg tubes 100 is configured to be matched with the single movable base 200.

In view of the above, the folding tent with caster structures further includes leg tube locking seats 110, where each of the leg tube locking seats 110 is mounted on the tent leg tube 100 in a sleeving manner, the tent leg tube 100 is divided into an upper leg tube 101 and a lower leg tube 102, the leg tube locking seat 110 is located between the upper leg tube 101 and the lower leg tube 102, the lower leg tube 102 is capable of extending and retracting in an inner cavity of the upper leg tube 101, and the leg tube locking seat 110 is configured to extending and retracting locking of the upper leg tube 101 and the lower leg tube 102; the leg tube locking seats 110 are common leg tube locking seats for the folding tent in the prior art, for example, a leg tube locking device for a folding tent disclosed in the publication number CN210622449U.

In view of the above, a hanging ring 111 is arranged on an outer side wall of each of the leg tube locking seats 110; the folding tent further includes a tent cover 300; the tent cover 300 includes a cover body and several hanging ropes 310; lower ends of the hanging ropes 310 are configured to be matched with the hanging rings 111; and when the folding tent is in a completely folded state, the tent cover 300 is capable of being sleeved outside the folding tent.

According to the present disclosure, by means of the movable bases, the folding tent can be conveniently moved, carried or fixed; particularly, after the folding tent is retracted and folded, in combination with the tent cover, it is convenient to store as a whole; and in combination with the switching of the positions of the rollers, it is convenient to move.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A folding tent with caster structures, comprising tent leg tubes, wherein a movable base is assembled at a bottom of each of the tent leg tubes; and each of the movable bases comprises a leg tube seat, a roller base, and a roller, the roller is mounted on one side of the roller base, the leg tube seat is mounted on the roller base, and the roller base is rotatable relative to the leg tube seat and is configured to move the roller.

2. The folding tent with caster structures according to claim 1, wherein an upper hinge hole is formed in each of the leg tube seats, a lower hinge hole is formed in each of the roller bases, and a mounting shaft is matched between the upper hinge hole and the lower hinge hole.

3. The folding tent with caster structures according to claim 1, wherein a guide post is arranged at a lower end of each of the leg tube seats, a guide groove is formed in each of the roller bases, and the guide post moves relative to the guide groove and moves the roller base along the leg tube seat; and each of the guide grooves is in an arc groove shape.

4. The folding tent with caster structures according to claim 1, wherein a leg tube embedding groove is formed in each of the leg tube seats, a fixing hole is formed in the leg tube seat, the bottom of the tent leg tube is embedded into the embedding groove, and a fixing member penetrates through the fixing hole to fixedly mount the tent leg tube and the leg tube seat.

5. The folding tent with caster structures according to claim 3, wherein two roller mounting arms are arranged on one side of each of the roller bases, the roller is located between the two roller mounting arms and is in rolling mounting fit through a roller shaft, and a lowest position of the roller is not lower than a horizontal plane where a bottom surface of the roller base is located.

6. The folding tent with caster structures according to claim 5, wherein the two rollers in the movable bases of the two adjacent tent leg tubes are capable of moving to a same outer side.

7. The folding tent with caster structures according to claim 6, wherein two movable bases are provided, four tent leg tubes are provided, the bottoms of two adjacent tent leg tubes are configured to be matched with the movable bases, and the bottoms of another two tent leg tubes are configured to be matched with fixed bases.

8. The folding tent with caster structures according to claim 6, wherein four movable bases are provided, four tent leg tubes are provided, and the bottom of each of the tent leg tubes is configured to be matched with the single movable base.

9. The folding tent with caster structures according to claim 1, further comprising leg tube locking seats, wherein each of the leg tube locking seats is mounted on the tent leg tube in a sleeving manner, the tent leg tube is divided into an upper leg tube and a lower leg tube, the leg tube locking seat is located between the upper leg tube and the lower leg tube, the lower leg tube is capable of extending and retracting in an inner cavity of the upper leg tube, and the leg tube locking seat is configured to extending and retracting locking of the upper leg tube and the lower leg tube.

10. The folding tent with caster structures according to claim 9, wherein a hanging ring is arranged on an outer side wall of each of the leg tube locking seats; the folding tent further comprises a tent cover; the tent cover comprises a cover body and several hanging ropes; lower ends of the hanging ropes are configured to be matched with the hanging rings; and when the folding tent is in a completely folded state, the tent cover is capable of being sleeved outside the folding tent.
